(19) United States
(12) Patent Application Publication
(10) Pub. No.: US 2015/0138087 A1
(43) Pub. Date: May 21, 2015

(54) HEAD-UP DISPLAY APPARATUS AND DISPLAY METHOD THEREOF

(71) Applicant: Hyundai Motor Company, Seoul (KR)

(72) Inventors: Dong Woo Kim, Hwaseong (KR); Ju Hyun Kim, Seoul (KR)

(21) Appl. No.: 14/340,987

(22) Filed: Jul. 25, 2014

(30) Foreign Application Priority Data
Nov. 15, 2013 (KR) 10-2013-0138975

(51) Int. Cl. G02B 27/01

(52) U.S. Cl. CPC G02B 27/0179; G02B 2027/0198
USPC 345/158

(57) ABSTRACT

A head-up display apparatus includes: a head-up display unit including a first region in which general driving information is displayed and a second region in which circumference environment interworking information is displayed; a position information obtaining unit that obtains position information on an obstacle in front of a vehicle; and a controlling unit that controls the head-up display unit to display the circumference environment interworking information in the first region when the obstacle in front of the vehicle is present within a preset first distance.

### CROSS-REFERENCE TO RELATED APPLICATION

This application is based on and claims under 35 U.S.C. §119(a) priority from Korean Patent Application No. 10-2013-0138975, filed on Nov. 15, 2013 in the Korean Intellectual Property Office, the disclosure of which is incorporated herein in its entirety by reference.

### BACKGROUND

(a) Field of the Invention

The present invention relates to a head-up display apparatus capable of displaying various information required for driving a vehicle on a front glass of the vehicle, and a display method thereof.

(b) Description of the Related Art

A display apparatus such as a navigation apparatus, or the like, mounted in a vehicle has been widely used since it may provide various information required for driving the vehicle and safety driving information. However, when a driver averts his/her eyes from the road in order to view a display screen, then a risk depending on dispersion of the driver's eyes increases.

Therefore, a head-up display apparatus has been developed in order to provide information required for driving the vehicle without dispersing the driver's eyes. In addition, a technology for providing augmented reality by matching display information to vehicle circumference environments (for example, a road, a building, and the like) through the head-up display apparatus has also been developed. However, since information is simply provided without considering an obstacle in front of the vehicle, the information is overlapped with the obstacle in front of the vehicle, such that it may be difficult for the information to be recognized.

### SUMMARY

One object to be achieved by the present invention is to provide a head-up display apparatus capable of providing stable and realistic information to a driver by changing a position of information displayed thereon depending on a distance up to an obstacle in front of a vehicle, and a display method thereof.

In one aspect of the present invention, there is provided a head-up display apparatus including: a head-up display unit including a first region in which general driving information is displayed and a second region in which circumference environment interworking information is displayed; a position information obtaining unit configured to obtain position information on an obstacle in front of a vehicle; and a controlling unit configured to control the head-up display unit to display the circumference environment interworking information in the first region when the obstacle in front of the vehicle is present within a preset first distance.

The first region may be positioned in a lower region of a plurality of regions linearly divided from a head-up display screen in a horizontal direction, and the second region may be positioned in a region other than the first region.

The controlling unit may control the head-up display unit to display the circumference environment interworking information in the second region when the obstacle in front of the vehicle deviates from a preset second distance in the state in which the circumference environment interworking information is displayed in the first region.

The preset second distance may be set to be larger than the preset first distance.

A difference between the preset first and second distances may be set to be in proportion to velocity, i.e., a speed of the vehicle.

The controlling unit may limit a display region of the circumference environment interworking information within the second region depending on a distance up to the obstacle in front of the vehicle when the circumference environment interworking information is displayed in the second region.

In another aspect of the present invention, there is provided a display method including: displaying general driving information in a first region of a head-up display screen; displaying circumference environment interworking information in a second region of the head-up display screen; obtaining position information on an obstacle in front of a vehicle; and displaying the circumference environment interworking information in the first region when the obstacle in front of the vehicle is present within a preset first distance.

In the displaying of the circumference environment interworking information in the second region, a display region of the circumference environment interworking information may be limited within the second region depending on a distance up to the obstacle in front of the vehicle.

The display method may further include displaying the circumference environment interworking information in the second region when the obstacle in front of the vehicle deviates from a preset second distance in the state in which the circumference environment interworking information is displayed in the first region.

The preset second distance may be set to be larger than the preset first distance.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a configuration of a head-up display apparatus according to an exemplary embodiment of the present invention;

FIG. 2 is a diagram for describing a head-up display screen according to an exemplary embodiment of the present invention;

FIGS. 3A and 3B are diagrams for describing a display method of circumference environment interworking information according to an exemplary embodiment of the present invention;

FIGS. 4A to 4C are diagrams for describing a display method of circumference environment interworking information according to another exemplary embodiment of the present invention;

FIG. 5 is a diagram for describing a display position changing condition of circumference environment interworking information according to an exemplary embodiment of the present invention; and

FIG. 6 is a flow chart for describing a display method according to an exemplary embodiment of the present invention.

### DETAILED DESCRIPTION OF THE PREFERRED EMBODIMENTS

Hereinafter, the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

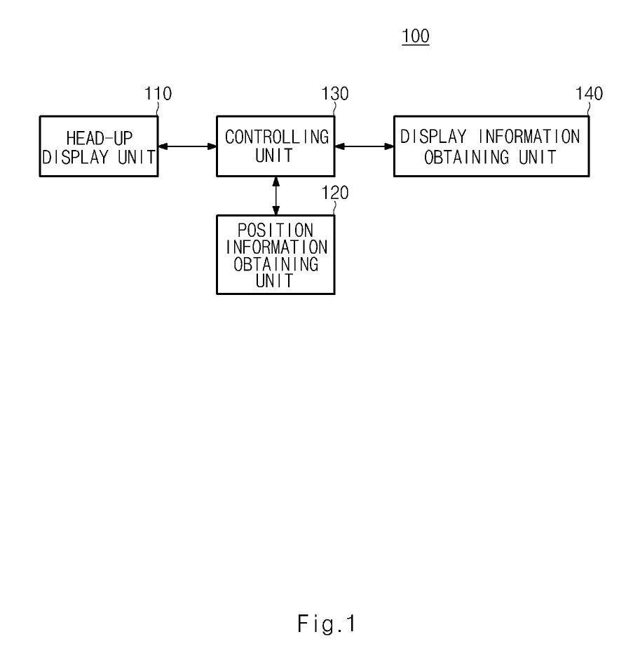

FIG. 1 is a block diagram illustrating a configuration of a head-up display apparatus according to an exemplary embodiment of the present invention.

Referring to FIG. 1, a head-up display apparatus 100 is configured to include a head-up display unit 110, a position information obtaining unit 120, a controlling unit 130, and a display information obtaining unit 140.

The head-up display unit 110 displays general driving information and circumference environment interworking information. As used herein, general driving information refers to general driving information that does not interwork with a vehicle circumference environment, such as a driving speed and fuel efficiency of a vehicle, internal/external temperatures of the vehicle, a fuel amount of the vehicle, and the like. In addition, circumference environment interworking information refers to information that interworks with the vehicle circumference environment, such as a path up to a destination, a speed limit of a road on which the vehicle is being driven, information on vehicle circumference facilities (for example, an oil station, a rest area, and the like), and the like. The head-up display unit 110 may match the circumference environment interworking information to an actual circumference environment and display the matched information.

The head-up display unit 110 may include a display element projecting the display information (for example, general driving information and circumference environment interworking information) on a front glass of the vehicle. Light projected from the display element may be reflected by the front glass of the vehicle, and a driver may view the display information through the front glass of the vehicle. Hereinafter, a region in which the information is displayed on the front glass of the vehicle by the display element is defined as a head-up display screen.

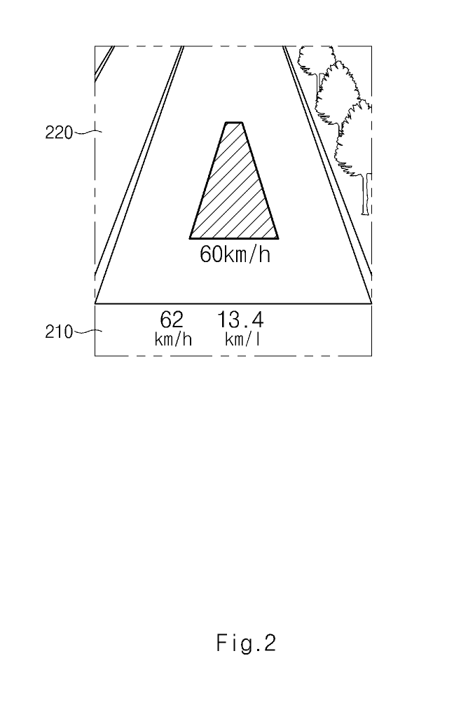

The head-up display unit 110 may include a first region in which the general driving information is displayed, and a second region in which the circumference environment interworking information is displayed. This will be described in detail with reference to FIG. 2.

FIG. 2 is a diagram for describing a head-up display screen according to an exemplary embodiment of the present invention.

Referring to FIG. 2, a head-up display screen of the head-up display unit 110 may include a first region 210 in which the general driving information is displayed, and a second region 220 in which the circumference environment interworking information is displayed. As illustrated in FIG. 2, the first region 210 may be positioned in a lower region of a plurality of regions linearly divided from the head-up display screen in a horizontal direction, and the second region 220 may be positioned in a region (that is, an upper region of the plurality of regions linearly divided from the head-up display screen in the horizontal direction) other than the first region.

Referring to FIG. 2, a current speed and fuel efficiency of the vehicle, which is general driving information, may be displayed in the first region 210. In addition, a speed limit, which is the circumference environment interworking information, may be displayed, together with an actual road on which the vehicle is being driven, in the second region 220.

The position information obtaining unit 120 obtains position information on an obstacle in front of the vehicle. More specifically, the position information obtaining unit 120 may include a radar sensor and may obtain position information on the obstacle in front of the vehicle through the radar sensor. The position information may include information on a distance from the vehicle to the obstacle and a width of the obstacle.

Meanwhile, since the radar sensor may obtain only information in a horizontal direction at a specific height, the position information obtaining unit 120 may further include a camera in order to obtain position information in a vertical direction, such as information on a height of the obstacle in front of the vehicle, or the like. The position information obtaining unit 120 may obtain the position information in the vertical direction, such as the information on the height of the obstacle in front of the vehicle, or the like, by processing an image in front of the vehicle photographed using the camera.

The controlling unit 130 may control a general operation of the head-up display apparatus 100. Particularly, the controlling unit 130 may control the head-up display unit 110 to display the circumference environment interworking information in consideration of the obstacle in front of the vehicle.

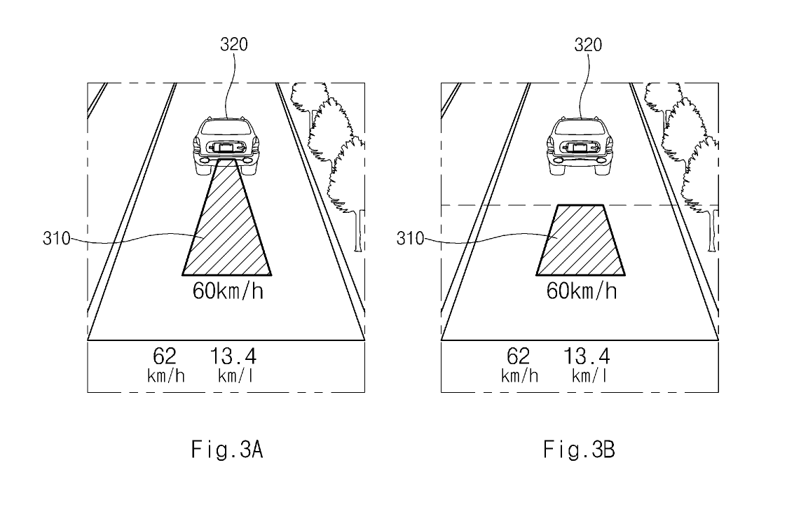

The controlling unit 130 may limit a display region of the circumference environment interworking information within the second region depending on the distance up to the obstacle in front of the vehicle when the circumference environment interworking information is displayed in the second region of the head-up display screen. This will be described in detail with reference to FIGS. 3A-3B.

FIGS. 3A and 3B are diagrams for describing a display method of circumference environment interworking information according to an exemplary embodiment of the present invention.

Referring to FIG. 3A, a phenomenon that circumference environment interworking information 310 is overlapped and viewed with an obstacle 320 in front of a vehicle based on a driver's eyes when the circumference environment interworking information is displayed in a second region of a head-up display screen occurs. In the case in which the circumference environment interworking information is displayed as illustrated in FIG. 3A, a display screen is unnaturally viewed, and it is difficult to identify the circumference environment interworking information. Therefore, the controlling unit 130 may limit a display region of the circumference environment interworking information depending on a distance up to the obstacle in front of the vehicle when the circumference environment interworking information is displayed in the second region.

Referring to FIG. 3B, a speed limit of a road on which the vehicle is being driven may be restrictively displayed only in a lower region of the second region so that the speed limit of the road on which the vehicle is being driven is not overlapped and viewed with the obstacle 320 in front of the vehicle. Meanwhile, as the obstacle in front of the vehicle becomes close to the vehicle, it has a feature that it descends from an upper portion to a lower portion on the head-up display screen. Therefore, the controlling unit 130 may further limit a region in which the circumference environment interworking information is displayed to the lower portion as the obstacle in front of the vehicle becomes close to the vehicle and may extend the region in which the circumference environment interworking information is displayed to the upper portion as the obstacle in front of the vehicle becomes distant from the vehicle.

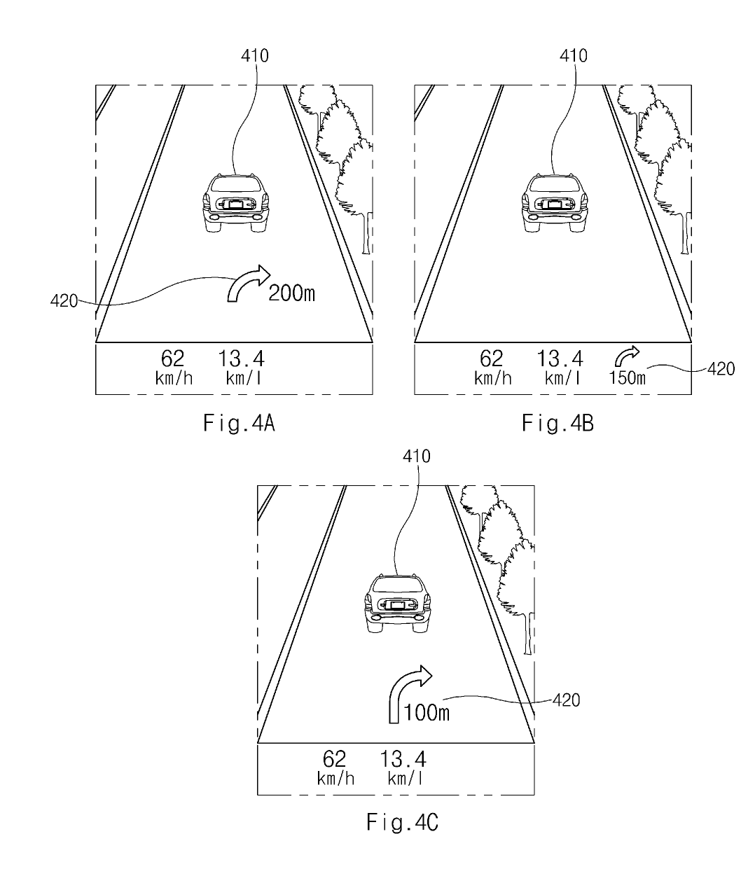

The controlling unit 130 may control the head-up display unit 110 to display the circumference environment interworking information in the first region of the head-up display screen when the obstacle in front of the vehicle is present within a preset first distance. In particular, the controlling unit 130 may control the head-up display unit 110 to display the circumference environment interworking information in the first region, in the case in which a distance up to the obstacle in front of the vehicle becomes closer than the preset first distance, such that it is impossible to display the circumference environment interworking information so as not to be overlapped and viewed with the obstacle in front of the vehicle within the second region. In addition, the controlling unit 130 may again control the head-up display unit 110 to display the circumference environment interworking information in the second region when the obstacle in front of the vehicle deviates from a preset second distance in the state in which the circumference environment interworking information is displayed in the first region. This will be described in detail with reference to FIGS. 4A to 4C.

FIGS. 4A to 4C are diagrams for describing a display method of circumference environment interworking information according to another exemplary embodiment of the present invention.

Referring to FIG. 4A, circumference environment interworking information 420 is restrictively displayed in only a lower portion of a second region of a head-up display screen due to an obstacle 410 in front of a vehicle. Here, when a distance up to the obstacle 410 in front of the vehicle becomes closer than a preset first distance, the controlling unit 130 may control the head-up display unit 110 to display the circumference environment interworking information 420 in a first region of the head-up display screen, as illustrated in FIG. 4B. Referring to FIG. 4B, the obstacle 410 in front of the vehicle is present within the preset first distance, such that the circumference environment interworking information 420 indicating a driven direction of the vehicle is displayed in the first region of the head-up display screen. Meanwhile, when the obstacle in front of the vehicle deviates from a preset second distance in the state in which the circumference environment interworking information is displayed in the first region as illustrated in FIG. 4B, the controlling unit 130 may control the head-up display unit 110 to display the circumference environment interworking information 420 in the second region as illustrated in FIG. 4C. Referring to FIG. 4C, the obstacle 410 in front of the vehicle is present out of the preset second distance, such that the circumference environment interworking information 420 indicating a driven direction of the vehicle is displayed in the second region of the head-up display screen.

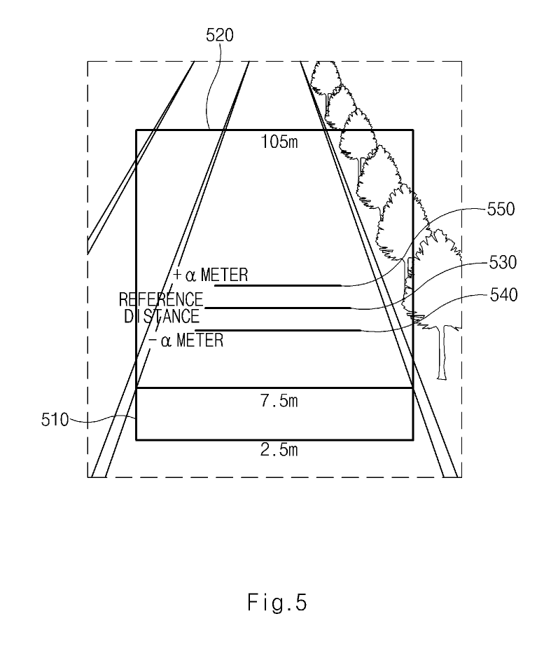

Meanwhile, although the preset first distance and the preset second distance may be set to be the same as each other, in the case in which the preset first distance and the preset second distance are set to be the same as each other, when the obstacle in front of the vehicle is present in the vicinity of the preset first distance, a position in which the circumference environment interworking information 420 is displayed may be frequently changed, thereby resulting in excessive changes in the display. Therefore, the preset second distance preferably is set to be larger than the preset first distance. In addition, a difference between the preset first and second distances may be set to be in proportion to velocity, i.e., a speed of the vehicle. This will be described in detail with reference to FIG. 5.

FIG. 5 is a diagram for describing a display position changing condition of circumference environment interworking information according to an exemplary embodiment of the present invention.

In FIG. 5, a portion of an environment viewed to a driver through a front glass of a vehicle is illustrated. Referring to FIG. 5, the front glass of the vehicle may include a head-up display screen, which may be divided into a first region 510 and a second region 520. Objects close to the vehicle are viewed in a lower portion of the front glass of the vehicle, and objects more distant from the vehicle are viewed toward an upper portion of the front glass of the vehicle, based on a visual field of the driver. A distance of a region in which the head-up display screen is viewed may be calculated depending on a distance up to an object in front of the vehicle, based on the visual field of the driver. For example, a lower portion of the first region may correspond to 2.5 m, a boundary between the first and second regions may correspond to 7.5 m, and a top of the second region may correspond to 105 m. However, they are only an example and may be changed depending on a position of the head-up display screen and a position of eyes of the driver.

Meanwhile, a reference distance may be set in order to set the preset first and second distances. For example, the reference distance may be set to be 15 m in front of the vehicle. Referring to FIG. 5, the reference distance 530 may be set to be positioned within the second region of the head-up display screen based on the visual field of the driver. The reference distance 530 may be a reference compared with the distance up to an obstacle in front of the vehicle to determine a display position (first region or second region) of the circumference environment interworking information.

When the reference distance is set, the preset first distance may be set to a reference distance −α, and the preset second distance may be set to a reference distance +α. Referring to FIG. 5, the preset first distance 540 is present below the reference distance 530 and the preset second distance 550 is present above the reference distance 530, based on the visual field of the driver. Here, α may be set to be in proportion to velocity. For example, a may be set to velocity×0.3 s.

Therefore, referring to FIG. 5, in the case in which the obstacle in front of the vehicle is present within the preset first distance (in the case in which the obstacle in front of the vehicle is positioned below the preset first distance 540 based on the visual field of the driver), the circumference environment interworking information may be displayed in the first region 510. Then, in the case in which the obstacle in front of the vehicle deviates from the preset second distance (in the case in which the obstacle in front of the vehicle is present above the preset second distance 550 based on the visual field of the driver), the circumference environment interworking information may be displayed in the second region 520.

In the case in which the obstacle is present in the vicinity of the reference distance, the preset first distance and the preset second distance may be set to be different from each other, thereby preventing a display position of the circumference environment interworking information from being excessively frequently changed. In addition, the a value may be set to be in proportion to the velocity, thereby preventing the display position of the circumference environment interworking information from being excessively frequently changed at a high speed at which a change in the distance up to the obstacle is large.

The display information obtaining unit 140 obtains display information to be displayed on the head-up display unit 110. More specifically, the general driving information may be obtained from various sensors mounted in the vehicle, such as a vehicle speed sensor, a fuel sensor, and the like, and the circumference environment interworking information may be obtained from a server, a navigation device, or the like, providing the vehicle circumference environment.

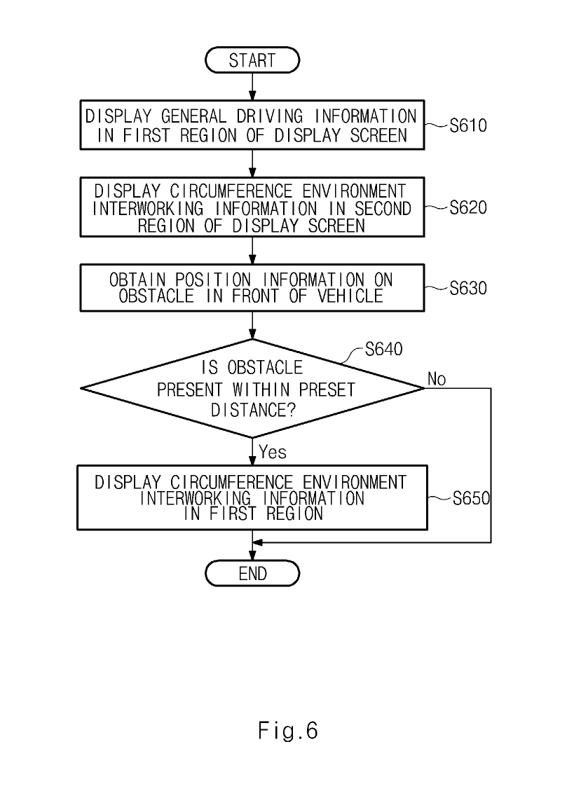

FIG. 6 is a flow chart for describing a display method according to an exemplary embodiment of the present invention.

The head-up display apparatus 100 first displays general driving information in a first region of a head-up display screen (S610). Then, the head-up display apparatus 100 displays circumference environment interworking information in a second region of the head-up display screen (S620). A display region of the circumference environment interworking information may be limited within the second region depending on a distance up to an obstacle in front of a vehicle when the circumference environment interworking information is displayed in the second region.

In particular, general driving information refers to general driving information that does not interwork with a vehicle circumference environment, such as a driving speed and fuel efficiency of a vehicle, internal/external temperatures of the vehicle, a fuel amount of the vehicle, and the like. In addition, circumference environment interworking information refers to information that interworks with the vehicle circumference environment, such as a path up to a destination, a speed limit of a road on which the vehicle is being driven, information on vehicle circumference facilities (for example, an oil station, a rest area, and the like), and the like.

In addition, the first region of the head-up display screen may be positioned in a lower region of a plurality of regions linearly divided from the head-up display screen in a horizontal direction, and the second region thereof may be positioned in a region (that is, an upper region of the plurality of regions linearly divided from the head-up display screen in the horizontal direction) other than the first region.

In addition, the head-up display apparatus obtains position information on the obstacle in front of the vehicle (S630). More specifically, the position information on the obstacle in front of the vehicle may be obtained through a radar sensor. The position information may include information on a distance from the vehicle to the obstacle and a width of the obstacle. In addition, the position information in the vertical direction, such as the information on a height of the obstacle in front of the vehicle, or the like, may be obtained by processing an image in front of the vehicle photographed using the camera.

Meanwhile, although the case in which the circumference environment interworking information is displayed after the general driving information is displayed has been described in FIG. 6, S610 to S630 may be performed in a temporally parallel relationship regardless of a sequence.

Then, the head-up display apparatus judges whether or not the obstacle in front of the vehicle is present within a preset first distance (S640). When it is judged that the obstacle in front of the vehicle is not present within the preset first distance (S640-N), the display method ends. In addition, when it is judged that the obstacle in front of the vehicle is present within the preset first distance (S640-Y), the head-up display apparatus displays the circumference environment interworking information in the first region of the head-up display screen (S650).

When the obstacle in front of the vehicle deviates from a preset second distance in the state in which the circumference environment interworking information is displayed in the first region, the circumference environment interworking information may be displayed in the second region. In particular, the preset second distance may be set to be larger than the preset first distance. In addition, a difference between the preset first distance and the preset second distance may be in proportion to velocity.

As set forth above, according to various exemplary embodiments of the present invention, the driver may effectively recognize information displayed on the head-up display screen without hindrance by the obstacle in front of the vehicle.

What is claimed is:

1. A head-up display apparatus comprising:
a head-up display unit including a first region in which general driving information is displayed and a second region in which circumference environment interworking information is displayed;
a position information obtaining unit configured to obtain position information on an obstacle in front of a vehicle; and
a controlling unit configured to control the head-up display unit to display the circumference environment interworking information in the first region when the obstacle in front of the vehicle is present within a preset first distance.

2. The head-up display apparatus according to claim 1, wherein the first region is positioned in a lower region of a plurality of regions linearly divided from a head-up display screen in a horizontal direction, and the second region is positioned in a region other than the first region.

3. The head-up display apparatus according to claim 1, wherein the controlling unit controls the head-up display unit to display the circumference environment interworking information in the second region when the obstacle in front of the vehicle deviates from a preset second distance in a state in which the circumference environment interworking information is displayed in the first region.

4. The head-up display apparatus according to claim 3, wherein the preset second distance is set to be larger than the preset first distance.

5. The head-up display apparatus according to claim 4, wherein a difference between the preset first and second distances is set to be in proportion to velocity.

6. The head-up display apparatus according to claim 1, wherein the controlling unit limits a display region of the circumference environment interworking information within the second region depending on a distance up to the obstacle in front of the vehicle when the circumference environment interworking information is displayed in the second region.

7. A display method, comprising:
displaying general driving information in a first region of a head-up display screen;
displaying circumference environment interworking information in a second region of the head-up display screen;
obtaining position information on an obstacle in front of a vehicle; and
displaying the circumference environment interworking information in the first region when the obstacle in front of the vehicle is present within a preset first distance.

8. The display method according to claim 7, wherein in the step of displaying the circumference environment interworking information in the second region, a display region of the circumference environment interworking information is limited within the second region depending on a distance up to the obstacle in front of the vehicle.

9. The display method according to claim 7, further comprising displaying the circumference environment interworking information in the second region when the obstacle in front of the vehicle deviates from a preset second distance in the state in which the circumference environment interworking information is displayed in the first region.

10. The display method according to claim 9, wherein the preset second distance is set to be larger than the preset first distance.
